(19) United States
(12) Patent Application Publication
(10) Pub. No.: US 2022/0329736 A1
(43) Pub. Date: Oct. 13, 2022

(54) PAYLOAD YAW ROTATION FOR FOCAL PLANE CROSS-TRACK COLUMNAR SCAN SAMPLING

(71) Applicant: Raytheon Company, Waltham, MA (US)

(72) Inventor: John B. Schlaerth, Redondo Beach, CA (US)

(21) Appl. No.: 17/227,997

(22) Filed: Apr. 12, 2021

(51) Int. Cl. H04N 5/232

(52) U.S. Cl. CPC H04N 5/23299; H04N 5/23212; H04N 2005/2255

(57) ABSTRACT

A system and method of operating a focal plane array of a camera assembly for a space vehicle in orbit includes scanning across a scene containing a target surface using the focal plane array, generating a plurality of sampled signals for the scene using a plurality of detectors of the focal plane array, co-adding the sampled signals to produce an output having a constant spatial resolution, and correcting a temporal shift in a line-of-sight of the focal plane array by rotating the space vehicle or the camera assembly to null relative motion at a center point of a scan.

### GOVERNMENT LICENSE RIGHTS

This disclosure was made with Government support under contract number 2018-660-004, awarded by the Department of Defense. The Government has certain rights in the disclosure.

### FIELD OF DISCLOSURE

The disclosure relates to a system and method of operating a focal plane array in a space vehicle.

### DESCRIPTION OF RELATED ART

A focal plane array, which is also referred to as a staring array, includes a plurality of light detectors arranged in a focal plane of an imaging system. Various applications may use focal plane arrays. Exemplary applications include space applications in which focal plane arrays are used to perform satellite imagery, such as for imaging a target surface in a scene of the Earth. The focal plane array is configured to record photons that hit each detector and transmit a corresponding signal to an onboard signal device in the space vehicle. The detector outputs are sampled and aggregated, or co-added, to provide a single output that has a constant spatial resolution.

In large format focal plane arrays used in low Earth orbit (LEO) scanning applications, the orbital velocity and proximity of the scene may result in a loss in the number of detectors that are able to sample the scene. Consequently, this results in losses in both resolution and the effective focal plane area. One prior attempt to address the losses includes using nearest neighbor interpolation via proximal signal to account for motion of the scene. The prior attempt is deficient in that using nearest neighbor interpolation may be lossy in gain and resolution, and may require a reduction in the active focal plane area required to resolve the scene.

### SUMMARY OF DISCLOSURE

The present application provides a system and method for operating a focal plane array in a camera assembly of an orbiting space vehicle that includes rotating the space vehicle to adjust an optical aperture to accommodate for a temporal line-of-sight shift of the focal plane array. Rotating the space vehicle may include rotating the camera assembly or an optical component of the camera assembly such as a mirror, or telescope. The focal plane array is configured to continuously scan across a scene that contains a target surface. For example, the space vehicle may be arranged in an Earth orbit such that the target surface is a single location located on the Earth. A plurality of sampled signals for the scene are generated using detectors and filter columns of the focal plane array. The scanning system uses time domain integration imaging in that the sampled signals are spectrally registered and co-added to produce an output having a constant spatial resolution.

The focal plane array scans across the scene in a direction that is perpendicular to an orbital velocity vector. The space vehicle, or an optical component of the scanning system, is rotated in a yaw direction relative to the orbital velocity vector. Filter columns that correspond to different bandwidths for light detection are arranged over the plurality of detectors in the focal plane array. By rotating the space vehicle, a same geolocation of the scene is sampled in a same one of the filter columns, such that the columns sample a same optimized consecutive portion of the scene during the scan.

Rotating the space vehicle during operation of the focal plane array is advantageous in that the space vehicle or the camera assembly images an independent scene along each detector column of the focal plane array such that relative motion is fully nulled at a center point of the scan. This is particularly advantageous in a scanning system that uses time phased spatial coaggregation to correct for the loss in the effective number of detectors that are available to sample the scene. This loss is caused by the orbital velocity relative to and in the proximity of the scene that occurs during normal operation of the scanning system.

In contrast to conventional methods, such as nearest neighbor interpolation, rotating the space vehicle to correct for temporal line-of-sight shifts enables the focal plane array to maintain a frame-rate, and a mirror, telescope, or other optical component of the space vehicle to maintain a scanning speed. Still another advantage is that the focal plane area of the focal plane array is maintained.

According to an aspect of the disclosure, a method of operating a focal plane array in a camera assembly of an orbiting space vehicle may include rotating the space vehicle or the camera assembly to correct for a temporal line-of-sight shift of the focal plane array.

According to an aspect of the disclosure, a method of operating a focal plane array may include co-adding sampled signals to produce an output having a constant spatial resolution.

According to an aspect of the disclosure, a method of operating a focal plane array may include sampling a same geolocation of a scene in a same filter column of the focal plane array.

According to an aspect of the disclosure, a scanning system for a space vehicle arranged in an Earth orbit may include a focal plane array and a controller configured to rotate the space vehicle or a camera assembly to correct a temporal shift in a line-of-sight of the focal plane array.

According to an aspect of the disclosure, a focal plane array may include a plurality of detectors configured to generate a plurality of sampled signals that are co-added and a plurality of filter columns arranged over the detectors.

According to an aspect of the disclosure, a method of operating a focal plane array in a camera assembly of a space vehicle in orbit includes scanning across a scene containing a target surface, generating a plurality of sampled signals for the scene using a plurality of detectors of the focal plane array, co-adding the sampled signals to produce an output having a constant spatial resolution, and correcting a temporal shift in a line-of-sight of the focal plane array by rotating the space vehicle or the camera assembly.

According to an embodiment of any paragraph(s) of this summary, the method may include rotating the space vehicle or the camera assembly to null relative motion at a center point of a scan.

According to an embodiment of any paragraph(s) of this summary, scanning across the scene may include scanning in a direction that is perpendicular to an orbital velocity vector.

According to an embodiment of any paragraph(s) of this summary, the method may include rotating the space vehicle or the camera assembly in a yaw direction relative to the orbital velocity vector.

According to an embodiment of any paragraph(s) of this summary, the method may include rotating the space vehicle or the camera assembly less than five degrees in the yaw direction.

According to an embodiment of any paragraph(s) of this summary, the method may include operating the focal plane array in an Earth orbit, wherein scanning across the scene includes scanning the target surface on the Earth.

According to an embodiment of any paragraph(s) of this summary, the method may include performing a yaw trim to compensate for rotation of the Earth.

According to an embodiment of any paragraph(s) of this summary, scanning across the scene may include using a plurality of filter columns arranged over the plurality of detectors in the focal plane array.

According to an embodiment of any paragraph(s) of this summary, the method may include sampling a same geolocation of the scene in a same one of the plurality of filter columns.

According to an embodiment of any paragraph(s) of this summary, co-adding the sampled signals may include adding a predetermined same one of the sampled signals from each of a plurality of multiple frames.

According to an embodiment of any paragraph(s) of this summary, the method may include maintaining a same or similar frame-rate of the camera assembly during the scanning.

According to an embodiment of any paragraph(s) of this summary, the method may include maintaining a scanning speed of the camera assembly.

According to an embodiment of any paragraph(s) of this summary, the method may include maintaining a focal plane area of the focal plane array.

According to another aspect of the disclosure, a scanning system for a space vehicle arranged in an Earth orbit includes a camera assembly including a focal plane array configured to scan across a scene containing a target surface on Earth, the focal plane array including a plurality of detectors configured to generate a plurality of sampled signals, a processor configured to co-add the sampled signals to produce an output having a constant spatial resolution, and a controller configured to rotate the space vehicle or the camera assembly to correct a temporal shift in a line-of-sight of the focal plane array and null relative motion at a center point of a scan.

According to an embodiment of any paragraph(s) of this summary, the focal plane array may include a multi-spectral filter having a plurality of filter columns arranged over the plurality of detectors.

According to an embodiment of any paragraph(s) of this summary, the controller may be configured to rotate the space vehicle or the camera assembly to enable sampling a same geolocation of the scene in a same one of the plurality of filter columns.

According to an embodiment of any paragraph(s) of this summary, the focal plane array may be configured to scan across the scene in a direction that is perpendicular to an orbital velocity vector, and wherein the controller is configured to rotate the space vehicle or the camera assembly in a yaw direction relative to the orbital velocity vector.

According to an embodiment of any paragraph(s) of this summary, the plurality of detectors may include an array of detectors having 1500 or more detectors along each of a width and a length of the array.

According to an embodiment of any paragraph(s) of this summary, the camera assembly may include a mirror or telescope.

According to an embodiment of any paragraph(s) of this summary, the space vehicle may be arranged in a low Earth orbit.

To the accomplishment of the foregoing and related ends, the disclosure comprises the features hereinafter fully described and particularly pointed out in the claims. The following description and the annexed drawings set forth in detail certain illustrative embodiments of the disclosure. These embodiments are indicative, however, of but a few of the various ways in which the principles of the disclosure may be employed. Other objects, advantages and novel features of the disclosure will become apparent from the following detailed description when considered in conjunction with the drawings.

### BRIEF DESCRIPTION OF DRAWINGS

The annexed drawings, which are not necessarily to scale, show various aspects of the disclosure.

FIG. 1 shows an exemplary space vehicle including a scanning system that is configured to perform satellite imagery when the space vehicle is in orbit.

FIG. 2 shows an exemplary scanning system for the space vehicle of FIG. 1 including a focal plane array.

FIG. 2A shows the space vehicle of FIG. 1 performing a scan of an Earth scene.

FIG. 3 shows an exemplary aggregation or co-addition of sampled signals in a scan direction of the focal plane array of FIG. 2.

FIG. 4 shows a line-of-sight for the focal plane array of FIG. 2 as the scanning system scans a scene.

FIG. 5 shows operation of the scanning system of FIG. 2 including a yaw rotation of the space vehicle.

FIG. 6 shows a schematic drawing of the scanning system of FIG. 2.

FIG. 7 shows a flowchart illustrating a method of operating a focal plane array of a space vehicle in orbit, such as the focal plane array of FIG. 2.

### DETAILED DESCRIPTION

The principles described herein have application in space vehicles or satellites that are arranged in space. An imaging system for performing satellite imagery is implemented in the space vehicle. The space vehicle may be launched and positioned in orbit, such as in an Earth orbit. The Earth orbit may be a low Earth orbit. Other Earth orbits may be suitable. Deep space applications may also be suitable. The method described herein may be used in closed loop across-track scanners that are used to obtain satellite images with optical cameras, such as a camera assembly that includes a focal plane array (or staring array). In other exemplary applications, the principles described herein may be used in operating a whisk broom or spotlight sensor. Other across-track scanning systems may also implement the method and system described herein.

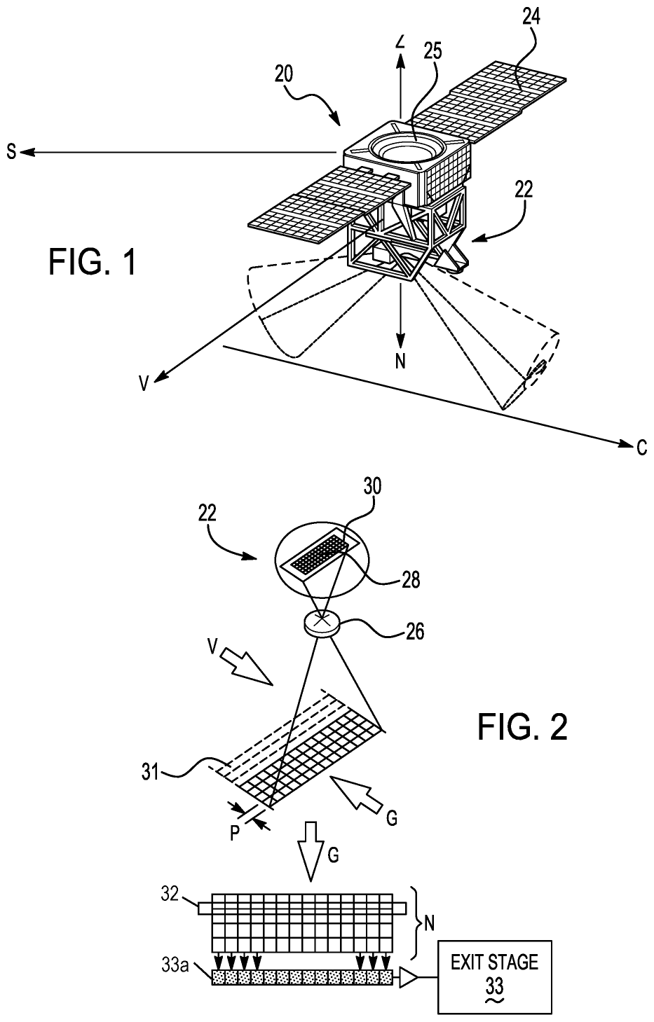

Referring first to FIG. 1, a space vehicle 20 is arranged in an Earth orbit, such as in a low Earth orbit. In other applications, the space vehicle 20 may be arranged in deep space. The space vehicle 20 may include a satellite or spacecraft payload configured to perform surveillance. A scanning system 22 is implemented in the space vehicle 20 and may be configured to perform satellite imagery. In an exemplary application in which the space vehicle 20 is arranged in an Earth orbit, the scanning system 22 may be used to continuously scan and image a desired location on the Earth. The space vehicle 20 is oriented to have a nadir direction N relative to the Earth, a zenith direction Z that extends in the opposite direction relative to the nadir direction N, and a sun-facing direction S that extends perpendicular relative to the nadir direction N and the zenith direction Z.

A solar array 24 is arranged on the space vehicle 20 for powering electronics of the space vehicle 20 during at least a portion of the orbit along which the space vehicle 20 travels. For example, the scanning system 22 may be powered using the solar array 24. A payload aperture or optical aperture 25 is arranged for passing light to an imaging device of the scanning system 22. The space vehicle 20 has a velocity vector V which is the direction in which the space vehicle 20 moves along the orbit (the orbital track) during scanning. The scanning system 22 is configured to scan in a cross-track direction C that is perpendicular to the velocity vector V. The scan may be a nadir cross-scan in the nadir direction N towards Earth.

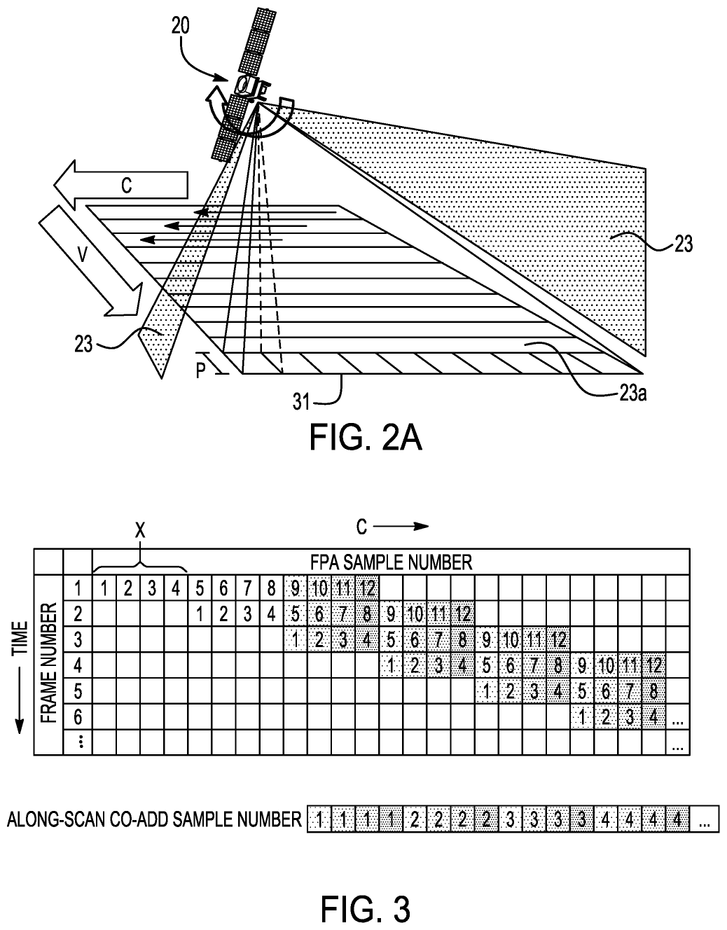

FIG. 2 shows an exemplary scanning system 22 that is arranged in the space vehicle 20 and FIG. 2A shows space views 23 of the space vehicle 20. The scanning system 22 includes a camera assembly that includes a head-mirror and/or a telescope 26, or any other suitable optical component, and a focal plane array 28 which is an active element in the camera assembly used to capture frames of data. The focal plane array 28 may be a time delay integration (TDI) charge-coupled device (CCD) that is an image sensor for capturing images of moving objects, such as a scene that includes a target surface or point of interest on the Earth.

The focal plane array 28 includes a plurality of CCD elements or detectors 30 that receive photons and transmit signals to capture a scene that is moving at a right angle relative to the plurality of detectors 30. The detectors 30 may be aligned to set a width of a swath 31 and are configured to scan successive pixel width lines P across the entire swatch 31. The focal plane array 28 may be a large format focal plane array, such as a focal plane array having 1500 or more detectors along each of a width and a length of a detector array. Fewer or more detectors may be used. For example, two or more detectors may be suitable. The focal plane array 28 is moving with the velocity vector V and is configured to image at a right angle relative to ground motion G. All of the detectors 30 image the scene through the telescope 26 and each detector 30 collects the light from a corresponding single ground element or pixel.

A plurality of filter columns are arranged over the plurality of detectors 30 and each filter column corresponds to a different bandwidth for light detection. The different bandwidths may correspond to visible, near-infrared, short-wave, middle-wave, long-wave, and day/night bands. During one scanned swath 31 which is a single pass of the scanning system 22 over the scene, the scanning system 22 may have a space view in which all bands are collected, a daytime view of the Earth in which visible and near-infrared bands are collected, a near terminator view of the Earth in which all bands are collected, and a nighttime view of the Earth in which short-wave, middle-wave, long-wave, and day/night bands are collected.

A grouping of pixel width lines constitutes an image. When the focal plane array 28 scans a pixel width line P, the detectors 30 sample the signal to generate a sampled signal 32. As shown in FIG. 2A, the pixel width lines P correspond to Earth data 23a. The sampled signals 32 are registered and co-added at an exit stage 33. The number N of the sampled signals 32 are then co-added from the rows across filter regions which are band dependent columns 33a. The number of co-added sampled signals 32 that is band dependent in that the spatial resolution per band may be user selectable depending on the application. The exit stage 33 thus produces an output that corresponds to an image of the scene with a constant spatial resolution. Advantageously, the sampled signals 32 may be summed while maintaining a speed of the space vehicle 20.

Referring in addition to FIG. 3, an exemplary aggregation or co-addition of sampled signals 32 for a scanning operation in the scan direction C is shown. The co-addition input includes a number of co-added frames of the sampled signals 32 from the focal plane array 28. In an exemplary operation, the line-of-sight of the focal plane array 28 may move four sampled signals X per frame. During co-addition, every fourth sampled signal 32 from multiple frames may be added. The co-addition may be timed to minimize smear or a blurred output, by matching a frame-rate to the scan speed of the telescope 26, or a head-mirror or other optical component of the scanning system 22.

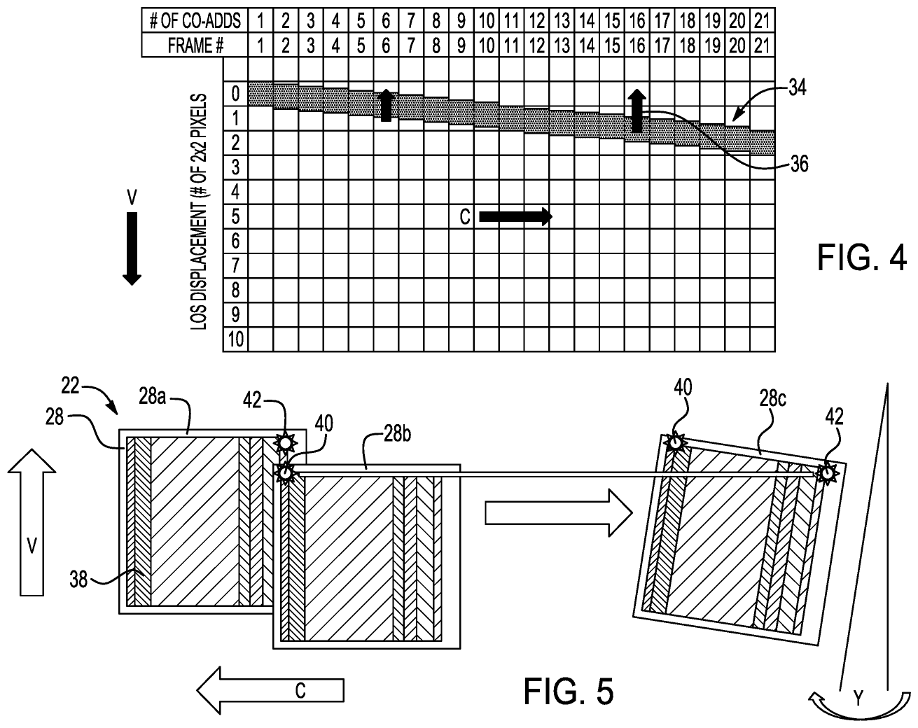

Referring in addition to FIG. 4, FIG. 4 shows the line-of-sight 34 for the focal plane array 28 as the scanning system 22 scans in the direction C perpendicular to the orbital velocity vector V. As shown in FIG. 4, the line-of-sight 34 is shifted or displaced in the direction of the orbital velocity vector V as subsequent frames are co-added, such that there are scan delays between the pixel rows P (shown in FIG. 2). The shift may be caused by orbital motion. Uncorrected optical distortion as shown in FIG. 4 may cause smear that occurs in each spectral band. Larger delays may occur for larger bandpass sizes and the spectral band-to-band line-of-sight registration at the exit stage 33 (shown in FIG. 2) may be delayed due to the distortion. FIG. 4 shows a correction 36 to be made to the line-of-sight 34.

Referring in addition to FIG. 5, the correction 36 to the line-of-sight shown in FIG. 4 is made by rotating the space vehicle 20 (shown in FIG. 1) in the yaw direction relative to the orbital velocity vector V. The space vehicle 20 or the camera assembly that includes the focal plane array 28 may be rotated to adjust the payload aperture or optical aperture 25 (shown in FIG. 1) relative to the orbital velocity vector V. In an exemplary embodiment, the entire camera assembly or a single optical component of the camera assembly may be rotated.

The scanning system 22 includes the focal plane array 28 having a multi-band filter with a plurality of different filters that each have a different column 38 for spectral band-to-band line-of-sight registration. Each filter column 38 pertains to a different bandwidth. The detectors are arranged under the plurality of different filters. The focal plane array 28 is shown at the end of a scan, indicated as the focal plane array 28a, and at the beginning of a scan, indicated as the focal plane array 28b. During the scan, the focal plane array 28 is shifted in the direction of the orbital velocity vector V as shown in comparing the focal plane arrays 28a, 28b.

By rotating the space vehicle 20 (or camera assembly or optical component of the scanning system 22) in the yaw direction Y, indicated as the focal plane array 28c, a same geolocation 40, 42 of the scene in a corresponding one of the plurality of filter columns 38 is sampled. Accordingly, the filter columns 38 are able to sample a same consecutive portion of the scene during the scan. The space vehicle 20 may be rotated continuously during the scan to accommodate for any temporal line-of-sight shifts throughout the scan.

In operation, a single point of interest on the surface of the Earth may be used as a reference point to determine shifts in the line-of-sight, along with the known frame-rate and rotation of the camera assembly including the focal plane array 28. The scanning system 22 may be configured to correct for the Earth's rotation, such as by performing a yaw trim. The scanning system 22 is configured to ensure that the camera assembly points downwardly toward the point of interest. The ground scene and edges of the scene as the scene moves are evaluated. The scanning system 22 or an operator trues the scene to the point of interest to ensure that the point of interest is seen in the same filter columns 38, such that a closed loop scan is provided. By adjusting the space vehicle 20 and the optical aperture 25, the scanning system 22 is tuned to a focal point of the focal plane array 28 such that relative motion is fully nulled at a center point of the scan, as shown in FIG. 5.

Advantageously, the temporal shift in the line-of-sight of the focal plane array 28 for an Earth-ground scene is corrected by adjusting the orientation of the space vehicle 20 without reducing or by only slightly reducing the active focal plane area of the focal plane array 28. The correction ensures precise radiometry. Without the correction, noise would increase due to the ability to track a signal from one column to the next. For example, edges of the focal plane would be lost due to the capturing of a different scene. A conventional method to accommodate for the shifting line-of-sight uses nearest neighbor interpolation in which proximal signals are matched across columns to account for motion of the scene. In contrast to using nearest neighbor interpolation, rotating the space vehicle 20 to correct the shifted line-of-sight is not a lossy method in that gain and resolution of the output are not compromised.

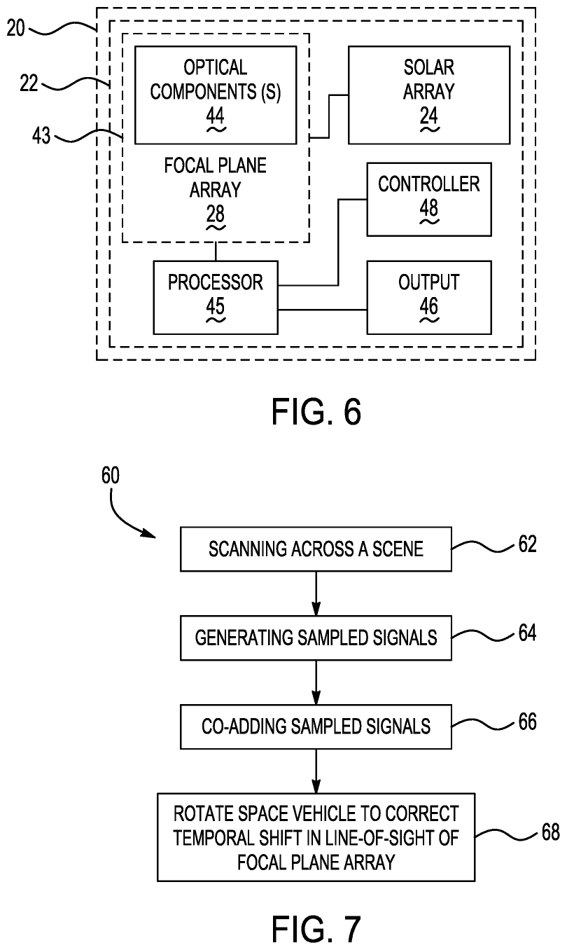

FIG. 6 shows a schematic drawing of the scanning system 22 (shown in FIGS. 1, 2, and 5) for the space vehicle 20 that includes the focal plane array 28 and the solar array 24. The focal plane array 28 is an element of a camera assembly 43 that also includes any other suitable optical components 44 for a camera or an imaging system including telescopes, mirrors, amplifiers, light sources, multiplexers, filters, radiators, etc. The camera assembly 43 or any of the optical components 44 may be rotated to compensate for a temporal shift in the line-of-sight of the focal plane array 28 and null relative motion at the center of the scan. For example, the camera assembly 43 may be gimballed to the space vehicle 20 such that the gimbal may be automatically adjusted to rotate the camera assembly 43.

An onboard signal and data processor 45 is configured to receive the sampled signals from the focal plane array 28 and produce an output 46 that corresponds to the scene and has a constant spatial resolution. The onboard signal and data processor may use any stored algorithms to compute and co-add the sampled signals. Any suitable electronics may be used for the focal plane array 28 and the onboard signal and data processor 45. A controller 48 is communicatively coupled to the processor 45 and is configured to receive a signal from the processor 45 to rotate the space vehicle 20 or the camera assembly 43 to adjust the optical aperture and correct for a temporal line-of-sight shift as determined by the processor 45.

The processor 45 may be configured to determine the amount of the yaw rotation required to correct the line-of-sight of the focal plane array 28 based on the sampled signals. The correction may be performed automatically or in response to a command received by an operator. The controller 48 may be configured to rotate the space vehicle 20 in a yaw direction by five degrees or less. The space vehicle 20 may also be rotated by greater or less than five degrees in other exemplary applications. An exemplary correction may include a yaw rotation of approximately 1.454 degrees. The processor 45 is also configured to provide a signal to the controller 48 to perform the yaw trim over the orbit to compensate for rotation of the Earth based on the detected images. For example, a yaw trim may occur on an order of +/−1.2 arc-minutes over each orbit.

FIG. 7 shows a flowchart for a method 60 of operating a focal plane array of a space vehicle in orbit, such as the focal plane array 28 for the space vehicle 20 shown in FIGS. 1, 2, 5, and 6. Step 62 of the method 60 includes scanning across a scene containing a target surface using the focal plane array 28. Step 62 may include operating the focal plane array 28 in an Earth orbit, such as a low Earth orbit and the target surface may be a target surface on the Earth that is continuously scanned. Scanning across the scene includes scanning in a cross-track direction C that is perpendicular to an orbital velocity vector V (shown in FIG. 1). A plurality of filter columns 38 may be arranged over a plurality of detectors 30 in the focal plane array 28 to be used during the scanning (shown in FIGS. 2 and 5). Each filter column 38 corresponds to a different bandwidth.

Step 64 of the method 60 includes generating a plurality of sampled signals 32 for the scene using the plurality of detectors 30 of the focal plane array 28 (shown in FIG. 2). Step 66 of the method 60 includes co-adding the sampled signals 32 to produce an output 46 having a constant spatial resolution. Co-adding the sampled signals 32 may include adding a predetermined same one of the sampled signals 32 from each of a plurality of multiple frames. For example, every fourth sampled signal 32 from multiple frames may be registered and added to produce a single output. The co-addition may be timed to minimize smear by matching the frame-rate to the scan speed of the camera assembly or an optical component of the scanning system 22.

Step 68 of the method 60 includes correcting a temporal shift in a line-of-sight of the focal plane array 28 by rotating the space vehicle 20, the camera assembly, or an optical component of the camera assembly that adjusts an optical aperture of the scanning system 22. Orbital motion causes temporal shifts in the line-of-sight and delays in spectral registration such that rotating the space vehicle 20 corrects the line-of-sight. Rotating the space vehicle 20 may include rotating the space vehicle in a yaw direction relative to the orbital velocity vector V. Step 68 may include rotating the space vehicle 20 less than five degrees. By rotating the space vehicle 20 to perform corrections, operating the focal plane array 28 may include sampling a same geolocation of the scene in a same one of the plurality of filter columns 38. The method 60 may also include performing a yaw trim to compensate for rotation of the Earth.

In contrast to conventional methods, the frame-rate of the focal plane array 28 and the scanning speed of a mirror or telescope 26 of the space vehicle 20 (shown in FIG. 2) may be maintained during the scanning, by rotating the space vehicle 20. Without rotating the space vehicle 20, the frame-rate and/or scan rate would have to be increased to provide a swatch-to-swatch overlap. A focal plane area of the focal plane array 28 may also be maintained by rotating the space vehicle 20.

Although the disclosure shows and describes certain preferred embodiment or embodiments, it is obvious that equivalent alterations and modifications will occur to others skilled in the art upon the reading and understanding of this specification and the annexed drawings. In particular regard to the various functions performed by the above described elements (external components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure. In addition, while a particular feature of the disclosure may have been described above with respect to only one or more of several illustrated embodiments, such feature may be combined with one or more other features of the other embodiments, as may be desired and advantageous for any given or particular application.

1. A method of operating a focal plane array in a camera assembly of a space vehicle in orbit, the method comprising:
scanning across a scene containing a target surface;
generating a plurality of sampled signals for the scene using a plurality of detectors of the focal plane array;
co-adding the sampled signals to produce an output having a constant spatial resolution; and
correcting a temporal shift in a line-of-sight of the focal plane array by rotating the space vehicle or the camera assembly.

2. The method according to claim 1, further comprising rotating the space vehicle or the camera assembly to null relative motion at a center point of a scan.

3. The method according to claim 1, wherein scanning across the scene includes scanning in a direction that is perpendicular to an orbital velocity vector.

4. The method according to claim 3 further comprising rotating the space vehicle or the camera assembly in a yaw direction relative to the orbital velocity vector.

5. The method according to claim 4 further comprising rotating the space vehicle or the camera assembly less than five degrees in the yaw direction.

6. The method according to claim 1 further comprising operating the focal plane array in an Earth orbit, wherein scanning across the scene includes scanning the target surface on the Earth.

7. The method according to claim 6 further comprising performing a yaw trim to compensate for rotation of the Earth.

8. The method according to claim 1, wherein scanning across the scene includes using a plurality of filter columns arranged over the plurality of detectors in the focal plane array.

9. The method according to claim 8 further comprising sampling a same geolocation of the scene in a same one of the plurality of filter columns.

10. The method according to claim 1, wherein co-adding the sampled signals includes adding a predetermined same one of the sampled signals from each of a plurality of multiple frames.

11. The method according to claim 1 further comprising maintaining a same or similar frame-rate of the camera assembly during the scanning.

12. The method according to claim 1 further comprising maintaining a scanning speed of the camera assembly.

13. The method according to claim 1 further comprising maintaining a focal plane area of the focal plane array.

14. A scanning system for a space vehicle arranged in an Earth orbit, the space vehicle comprising:
a camera assembly including a focal plane array configured to scan across a scene containing a target surface on Earth, the focal plane array including a plurality of detectors configured to generate a plurality of sampled signals;
a processor configured to co-add the sampled signals to produce an output having a constant spatial resolution; and
a controller configured to rotate the space vehicle or the camera assembly to correct a temporal shift in a line-of-sight of the focal plane array and null relative motion at a center point of a scan.

15. The scanning system according to claim 14, wherein the focal plane array includes a multi-spectral filter having a plurality of filter columns arranged over the plurality of detectors.

16. The scanning system according to claim 15, wherein the controller is configured to rotate the space vehicle or the camera assembly to enable sampling a same geolocation of the scene in a same one of the plurality of filter columns.

17. The scanning system according to claim 14, wherein the focal plane array is configured to scan across the scene in a direction that is perpendicular to an orbital velocity vector, and wherein the controller is configured to rotate the space vehicle or the camera assembly in a yaw direction relative to the orbital velocity vector.

18. The scanning system according to claim 14, wherein the plurality of detectors includes an array of detectors having 1500 or more detectors along each of a width and a length of the array.

19. The scanning system according to claim 14, wherein the camera assembly includes a mirror or telescope.

20. The scanning system according to claim 14, wherein the space vehicle is arranged in a low Earth orbit.

21. The method of claim 1, wherein the correcting the temporal shift includes rotating the space vehicle.

22. The method of claim 1, wherein the correcting the temporal shift includes rotating the camera assembly, including rotating the focal plane array as part of rotating the camera assembly.
